(19) United States
(12) Patent Application Publication
(10) Pub. No.: US 2024/0024720 A1
(43) Pub. Date: Jan. 25, 2024

(54) SPORTS DEVICE COMPRISING SENSORS AND LIGHT SOURCES

(71) Applicant: Salto Koblenz GmbH, Koblenz (DE)

(72) Inventor: Peter Gavrish, Neuwied (DE)

(21) Appl. No.: 18/221,082

(22) Filed: Jul. 12, 2023

(30) Foreign Application Priority Data
Jul. 19, 2022 (DE) 20 2022 104 069.9

(51) Int. Cl. A63B 5/11; A63B 71/06; H05B 47/13; F21V 33/00

(52) U.S. Cl. CPC A63B 5/11; A63B 71/0622; H05B 47/13; F21V 33/008; H04R 1/028

(57) ABSTRACT

A sports device is provided including a plurality of trampolines each having a trampoline bed, a lighting system, a sensor device and a control unit, the trampolines together forming a jumping field. The sensor device being designed to detect position data of at least one person on the trampolines. The control unit being designed to receive the position data from the sensor device and to control the lighting system as a function of the position data. The lighting system being designed to illuminate the trampolines individually, a plurality of the trampolines or all of the trampolines as a function of the control by the control unit.

### CROSS-REFERENCE TO RELATED APPLICATIONS

This application claims priority to German Application No. 20 2022 104 069.9, having a filing date of Jul. 19, 2022, the entire contents of which are hereby incorporated by reference.

### FIELD OF TECHNOLOGY

The following relates to a sports device comprising sensors and light sources.

### BACKGROUND

Trampolines are sports equipment that facilitate a person's jumping. They usually include a trampoline bed stretched at a certain distance above the ground and suspended elastically in a frame. When a user is on the trampoline bed, his or her own weight presses on the trampoline bed so that it is stretched toward the ground.

If the person now performs a jumping movement, i.e., a movement upwards, not only his or her own force but also the restoring force of the trampoline bed acts on his or her body, causing the jump to be higher. To further support jumping, the trampoline bed can additionally be suspended from the frame via coil springs.

### SUMMARY

An aspect relates to sports equipment and in particular trampoline equipment that can be used for sports games or similar movement activities. Sports games are activities in which the participants move around the facility according to certain rules.

In a first aspect, embodiments of the invention relate to a sports device comprising a plurality of trampolines each having a trampoline bed, a lighting system, a sensor device, and a control unit. The trampolines together form a jumping field. The sensor device is adapted to detect position data of at least one person on the trampolines. The control unit is designed to receive the position data from the sensor device and to control the lighting system as a function of the position data. The lighting system is designed to illuminate individual trampolines, several trampolines or all trampolines depending on the control by the control unit.

Trampolines and their jumping areas, which are essentially formed by the trampoline beds, can basically have any shape. There are, for example, angular, in particular rectangular or square trampoline beds, round or elliptical trampoline beds and trampoline beds with more complex and asymmetrical shapes. In the context of embodiments of the invention, rectangular trampoline beds are because they can be arranged most compactly to form a large jumping area, the jumping field. Compact arrangements of trampolines are advantageous because, first, they maximize the jumping area per area of the sports device and, second, they reduce the risk of injury to persons due to the non-elastic frames or the spaces between the trampolines.

In the context of embodiments of the present invention, “a plurality of trampolines” means that the sports device comprises at least two trampolines. In an embodiment, the sports device comprises four or more trampolines and the sports device comprises 16 or more trampolines.

In an embodiment, the plurality of trampolines are arranged to form a rectangular jumping field. In particular, the trampolines can form a jumping field of 4×4, 5×5, 4×5 or any other combination with more than 2×2 trampolines.

In the context of embodiments of the present invention, the directions ‘up’ or ‘above’ and ‘below’ or ‘under’, respectively, are used. ‘Up’ in any case means ‘away from the ground’ on which the trampolines are placed. However, ‘above’ does not necessarily mean ‘vertically above. Similarly, ‘down’ in any case means ‘towards the ground’ on which the trampolines stand. ‘Below’, however, does not necessarily mean ‘vertically below. A first object, in the context of embodiments of the present invention, positioned above a second object is at a greater distance from the ground than the second object. Conversely, a first object positioned below a second object is at a lesser distance from the ground than the second object.

In one embodiment, the trampoline beds of the trampolines are angled upward at one or more edges of the jumping field so that their jumping support for the person jumping does not act vertically upward, but toward the center of the jumping field. For example, the trampoline bed may be angled upward at an angle of 30° to 60° relative to the ground. In an embodiment, the angle is 45°.

The sensor device is designed to detect position data of at least one person on the trampolines. In the context of embodiments of the invention, the term ‘person’ or ‘persons’ basically means the person or persons who are on the trampoline, unless otherwise described.

The position data may comprise the coordinates of the person relative to the sports device or, for example, the room in which the sports device is located. Alternatively, or additionally, the position data may comprise a trampoline identifier uniquely associated with one of the plurality of trampolines of the sports device.

The control unit processes the position data it receives from the sensor device. The control unit can be, for example, a commercially available computer, an FPGA (Field Programmable Gate Array), a microcontroller or any other electronic device suitable for controlling the lighting system as a function of the position data.

Controlling the lighting system in response to the position data may include having the lighting system illuminate or not illuminate portions of the jumping field, depending on whether or not a person is near a sensor.

For example, one activity mode that can be provided with the sports device according to embodiments of the invention is that the person must follow a sequence of illuminated trampolines. In this case, the person jumps from trampoline to trampoline, and with each jump follows the lighting that identifies the next trampoline to be jumped on. To do this, a selection of the plurality of trampolines is illuminated by the lighting system. When the sensor device detects that a person is on an illuminated trampoline, it sends a corresponding signal to the control device. The control device processes the signal and controls the lighting system to no longer illuminate the trampoline on which the person is located.

Conversely, embodiments of the invention can also be used such that the control device controls the lighting system such that the lighting system illuminates just the trampoline on which the person is located.

The lighting system can also be designed to illuminate the entire jumping field. However, the lighting system must then be designed to reduce the illumination to individual trampolines or a selection of trampolines that are not necessarily adjacent to each other. In such an embodiment, the goal of the activity could be, for example, to reach all trampolines at least once, so that at the beginning of the activity all trampolines are illuminated, and the illumination of a trampoline then goes out when the person has reached the corresponding trampoline. If no more trampolines are illuminated, the activity is finished.

In one embodiment, the lighting system includes a plurality of light sources, at least one of the light sources being associated with each of the trampolines.

In an manner, the illumination of individual trampolines is simplified by the use of light sources assigned to the trampolines. If only one light source were to be used in accordance with embodiments of the invention, such a light source would either have to be designed to be movable and/or to operate with some sort of mask that would dim the areas of the trampolines that were not to be illuminated. In any case, such a system would be more complex and have moving parts that are prone to failure.

The use of dedicated light sources for each trampoline eliminates the need for moving parts. Furthermore, the light sources can be replaced more easily in case of malfunctions, as the individual light sources can be replaced more easily.

In one embodiment, the light sources have different colors, and the control unit is designed to control individual light sources depending on the position data and the color of the respective light source.

Colored light sources increase the complexity of the modes that embodiments of the invention can provide as a sports activity. The sports activities can thus be made more varied and challenging, so that not only the person's body can be trained, but also the person's mind, especially concentration and attention.

Embodiments of the invention can, for example, be designed in such a way that several light sources with different colors are assigned to each trampoline. The person then not only has to pay attention to which trampolines are illuminated and which are not. The person also has to make sure that he or she only use the trampolines for his or her activity that have a certain color, for example.

In an alternative embodiment, the colors may respond to the position of the person. For example, one mode may be that stepping on the trampolines is only allowed a certain number of times before the activity ends. For example, a certain selection of trampolines may be illuminated green, where green light means that the trampoline illuminated green may be stepped on three times. If the sensor device detects a person on a green-lit trampoline, the control unit can change the color of the lighting from green to, for example, yellow to indicate to the person that he or she may only step on this trampoline two more times. The last step could be indicated by red light, for example, and if the trampoline is no longer available for the activity, the control unit would control the lighting system so that the trampoline in question is no longer illuminated at all.

Colored light sources can therefore significantly increase the complexity of the activity modes provided, which in turn increases the training effect for the person.

In one embodiment, the light sources illuminate the trampolines from below, and the trampoline beds are configured to transmit some of the light from the light sources upward.

In a manner, the light sources in this embodiment can be arranged under the trampolines and in particular under the trampoline beds. This has the effect that the light sources are easily accessible for maintenance purposes and the trampoline beds are more sharply illuminated when viewed from above, i.e., the light from the light sources only illuminates the trampoline beds and not, for example, the intermediate areas between the trampolines.

The trampoline bed can transmit light upward in two ways in particular. In the first, the trampoline beds can be made of a sufficiently thin material or a transparent material so that light shines through the trampoline beds. In the second possibility, the trampoline beds may have meshes that are sufficiently large that light can shine through them.

In one embodiment, the light sources are arranged in a housing with an open or transparent top surface.

The housing protects the light sources from damage. In particular, if too heavy persons or too many persons use a sports device with trampolines, the trampoline bed may extend downwards beyond an intended extent. A housing protects on the one hand the light sources under the trampoline bed and on the other hand the persons and the trampoline bed from damage by contact with a possibly hot or destroyed light source.

For example, the housing can be a cage that is sufficiently stable while allowing the light from the light source to shine upward. The top surface of the housing must be such that the light from the light source is not completely blocked upward. For example, the housing may include a transparent plastic lid or a grille. Alternatively, the housing may be open, in which embodiment it must be noted that the opening must not be large enough to allow the trampoline bed to expand into the housing and thereby damage the light source therein.

In one embodiment, the sensor device comprises motion sensors.

Motion sensors are sensors that can detect a movement of a physical body, especially a person, within a certain range.

Motion sensors can be used to directly communicate the presence of a person to the control unit based on motion in the monitored area. The output signal of a motion sensor can, for example, be binary, i.e., “person present”/“motion detected” or “person not present”/“no motion detected”. Binary signals are easy to process in signal processing. For example, each trampoline can be assigned a binary motion sensor whose signal is forwarded to one or more light sources via the control device. By assigning each sensor, the control unit can extract the position data from the signals of the sensor device.

More complex and in particular imaging motion sensors are also possible. Imaging motion sensors are motion sensors that detect a movement with the aid of imaging processes. The movement is not only detected, but can also be assigned to a specific position. For example, an imaging motion sensor can monitor one or more trampolines. If a person steps on one of the monitored trampolines, the associated movement of the person is detected and assigned to a position. Using an image processing algorithm, the control unit can extract the position data of a person from the signal of the motion sensor.

Binary sensors have the advantage that they are less complex in design compared to imaging sensors. Imaging sensors have the advantage that a larger area can be monitored with one sensor and depending on the resolution of the imaging process, so that fewer sensors are required compared to binary sensors. For example, a sports device described herein may have one binary motion sensor per trampoline or one imaging sensor for the entire device. Combinations and variations that combine different sensors are also possible.

In one embodiment, the motion sensors include infrared and/or radar sensors.

Both infrared and radar sensors are known types of sensors that are inexpensive to acquire. The use of such sensors causes the sports device to be less expensive.

In one embodiment, the sensing device includes electronic, electromechanical, and/or mechanical sensors on each of the trampolines to detect the position of a user on the trampolines based on physical characteristics of the trampolines or parts thereof.

The cost of electronic, electromechanical or mechanical sensors is often low, keeping the cost of the overall sports device low.

Capacitive sensors, for example, can be used as electronic sensors to measure the capacitance of a trampoline bed or a spring on the frame of a trampoline. If the trampoline bed or spring is stretched, its electrical capacitance changes, which can be measured by a sensor. Mechanical sensors, for example, can measure the force acting on a spring or the trampoline as a whole. If the trampoline or trampoline bed is at rest, the sensor is in equilibrium. If the trampoline bed or trampoline is moved, a force is acting that can be measured by a sensor. If each trampoline is equipped with such a sensor and an output signal is combined with the assignment of the respective sensor to the trampoline, this results in position data of a person on the trampolines.

In one embodiment, the sports device comprises a loudspeaker system, wherein the control unit is configured to control the loudspeaker system depending on the position data.

A loudspeaker system expands the range of uses and the number of modes that can be performed with the sports device. Sports games that can provide acoustic feedback in addition to visual user feedback offer the possibility that even more senses are stimulated when using the sports device, which can increase the training effect.

For example, a loudspeaker system can emit signals that command persons to stop or move on. In conjunction with the lighting system, a sports device can also signal more complex rules, for example that persons are only allowed to move on certain trampolines if a certain sound is played and at the same time these trampolines are illuminated. A game can be particularly complex if the lighting also includes colored light that persons must consider. Such stimulation of sensory perception during sports promotes concentration. Therefore, a suitably equipped sports device can increase the training complexity for the person.

In one embodiment, the loudspeaker system includes a plurality of loudspeakers.

In particular, several loudspeakers connected together can have the effect of producing a sound in the room that persons can locate, so-called 3D audio or 3D hearing. In an embodiment, the control device is designed to control the loudspeakers so that they produce sounds or tones depending on the position data.

The use of multiple loudspeakers has the effect of making the sports device more versatile and the associated sports offering more varied for the persons.

In one embodiment, the loudspeakers are arranged circumferentially around the jumping field.

For example, this embodiment may be configured such that the jumping field has a rectangular footprint and loudspeakers are located on each of the four perimeter sides. The loudspeakers can then be used to allow persons to move, for example, only in directions indicated by the output of the loudspeakers. In combination with the lighting system according to embodiments of the invention, the device can make the procedure even more complex in that the persons are not only allowed to move only in a certain direction, but also have to pay attention to the lighting of trampolines, in particular colored lighting of trampolines.

In an advantageous way, the use of loudspeakers arranged around the jumping field causes that the jumping field can be sounded from all sides, so that each played sound or noise can be assigned a direction which has to be considered in an activity.

In one embodiment, a loudspeaker is assigned to each trampoline. In an embodiment, the loudspeaker of each trampoline is arranged above or below the trampoline.

In a way, the association of a loudspeaker with a trampoline has the effect that, via the playing of sounds or tones, it is possible to indicate to the persons not only a direction but also a location, that is, a particular trampoline or, in the case of several loudspeakers controlled simultaneously, a particular group of trampolines used for the activity.

In one embodiment, the sports device comprises one or more switching devices for completely switching off the lighting system and/or the loudspeaker system. Switching devices can also be used in those sports devices that do not comprise a loudspeaker system.

In a manner, such switching devices, also referred to as dead man's switches, can be used to switch off the sports equipment and in particular its electronic devices if the lighting effects of the lighting system and/or the sounds and tones of the loudspeaker system would interfere. This may be the case, for example, if a person has been injured and needs emergency medical treatment. In particular, injuries can occur on trampolines. The emergency physician's concentration could be impaired by changing light conditions and sounds and tones that are played over and over again, which would not ensure optimal treatment of the injured person. In this sense, the claimed switching device or devices would improve the treatment conditions for persons injured on the sports device.

In one embodiment, pads and/or obstacles are arranged between the trampolines. Pads between the trampolines increase the protection of the persons when jumping from one trampoline to another. Obstacles, especially air-filled or inflatable obstacles, can increase the complexity of the activities that can be performed with the sports device.

In one embodiment, the jumping field is surrounded by a net or a grid. In an embodiment, the net or the grid is arranged directly at the edge of the jumping field.

A net or grid prevents persons from falling off the trampolines over the edge of the jumping field and injuring themselves.

### BRIEF DESCRIPTION

Some of the embodiments will be described in detail, with references to the following Figures, wherein like designations denote like members, wherein:

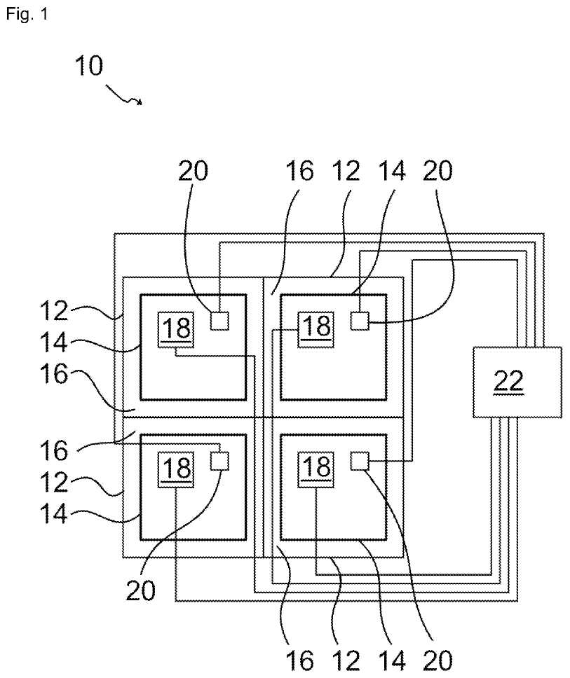

FIG. 1 shows an embodiment of the sports device with four trampolines;

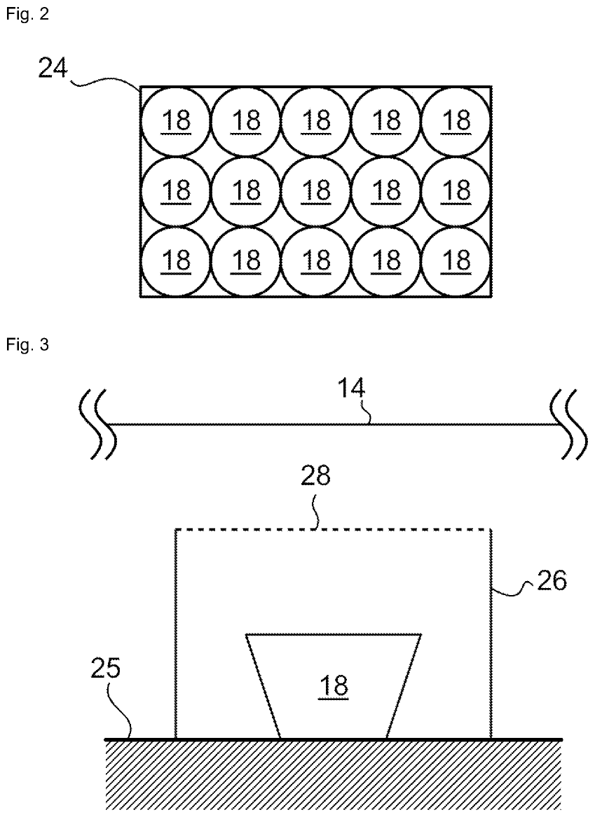

FIG. 2 shows a lighting system with multiple light sources;

FIG. 3 shows the arrangement of a light source with housing under a trampoline bed; and

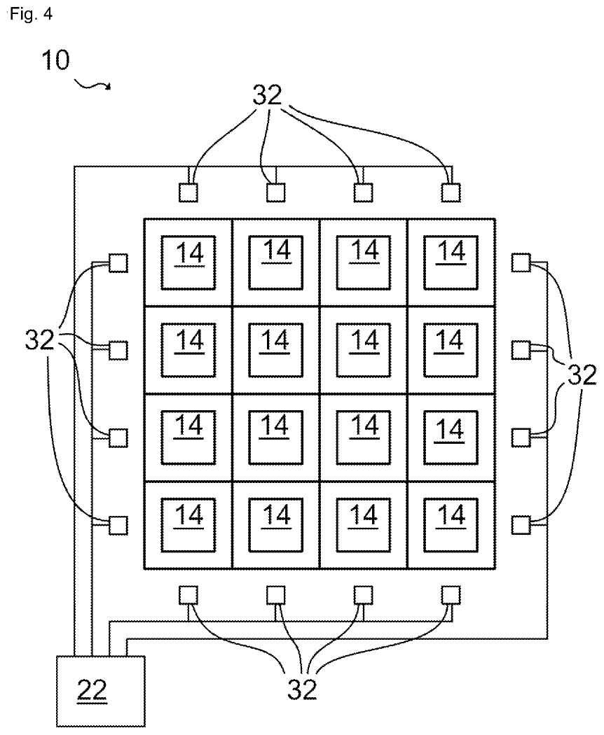

FIG. 4 shows a sports device with 16 trampolines.

### DETAILED DESCRIPTION

FIG. 1 schematically shows a sports device 10 with four trampolines 12. Each of the trampolines has its own trampoline bed. The space 16 between the trampolines is padded in this embodiment.

The sports device has a lighting system, which in this embodiment comprises four light sources 18, each of which is associated with one of the four trampolines 12. The sports device further comprises a sensor device formed by four sensors 20. Each of the sensors 20 is associated with one of the four trampolines 12.

Both the sensors 20 and the light sources 18 are communicatively connected to a control unit 22, so that the control unit 22 can receive signals from the sensors 20 and process them into control signals for the light sources 18.

The light sources 18 may, for example, be formed by a plurality of LEDs, which may in particular have different colors. The control unit 22 can not only switch such a light source 18 on and off, but also adjust the individual colors of the light source 18 so that the trampoline beds 14 are illuminated in different colors.

The communication links between the light sources 18 and the control unit 22 and between the sensors 20 and the control unit 22 may be wired communication links or wireless communication links.

FIG. 2 shows a schematic representation of an embodiment of a lighting system 24 with 15 light sources 18. The light sources 18 can each be individually controlled by a control unit 22. Furthermore, the light sources 18 can each be aligned in the lighting system 24 in such a way that each of the light sources 18 illuminates one trampoline 12.

In an alternative embodiment, the light sources 18 may also be equipped with motors that can change the orientation of the light sources 18. A control unit 22 could then be designed, for example, to control the motors and thus move the light cones of the light sources 18 so that they are aligned with other trampolines 12 after being controlled.

In another embodiment, the light cones of the light sources 18 can be moved using a mask by the control unit adjusting movable shutters of the mask.

FIG. 3 schematically shows the arrangement of a light source 18 under a trampoline 12. The light source 18 stands on the ground 25 and is protected from dirt or damage by a housing 26. The housing 26 is designed in such a way that the light from the light source 18 can shine upwards out of the housing 26. To this end, the housing may have a transparent or semi-transparent top surface 28. The top surface 28 may, for example, be formed as a grid, as a transparent plastic pane or as an opening. The latter, however, must be sufficiently small so that the trampoline bed 14 does not stretch into the opening. This is because doing so could damage a person on the trampoline bed 14 as well as the trampoline bed 14 itself or the light source 18.

FIG. 4 shows a schematic illustration of an embodiment of the sports device with 16 trampolines 12, each of which has a trampoline bed 14. The trampolines 12 together form a jumping field 30.

The jumping field 30 is surrounded by a loudspeaker system that includes a plurality of loudspeakers 32. The loudspeakers 32 are arranged in circumferential direction around the jumping field 30. The jumping field 30 is rectangular and even square in shape, so that an equal number of loudspeakers 32 are arranged on each side of the jumping field 30.

The loudspeakers 32 can be used to indicate a direction to persons on the trampolines 12 so that they move to one side of the jumping field 30 or away from one side of the jumping field 30, for example.

The loudspeakers 32 are each communicatively connected to the control unit 22. The communication link between the control unit 22 and the loudspeakers 32 may be a wired or a wireless communication link.

In particular, Bluetooth or Wi-Fi connections can be used as wireless communication links.

Although the invention has been illustrated and described in greater detail with reference to the exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

### LIST OF REFERENCE SIGNS

10 Sports device
12 Trampoline
14 Trampoline bed
16 Space between the trampolines
18 Light source
20 Sensor
22 Control unit
24 Lighting system
25 Floor
26 Housing
28 Top surface
30 Jumping field
32 Loudspeaker

1. A sports device comprising:
several trampolines, each with a trampoline bed,
a lighting system,
a sensor device, and
a control unit,
wherein the trampolines together form a jumping field,
wherein the sensor device is configured to detect position data of at least one person on the trampolines,
wherein the control unit is configured to receive the position data from the sensor device and to control the lighting system as a function of the position data,
wherein the lighting system is configured to illuminate the trampolines individually, several of the trampolines or all of the trampolines depending on the activation by the control unit.

2. The sports device according to claim 1, wherein the lighting system further comprises a plurality of light sources, at least one light source being associated with each of the trampolines.

3. The sports device according to claim 2, wherein the light sources have different colors, the control unit being configured to control individual light sources as a function of the position data and the color of the respective light source.

4. The sports device according to claim 2, wherein the light sources illuminate the trampolines from below, the trampoline beds being configured to transmit some of the light of the light from the light sources upwardly.

5. The sports device according to claim 4, wherein the light sources are arranged in a housing having an open or transparent top surface.

6. The sports device according to claim 1, wherein the sensor device further comprises motion sensors.

7. The sports device according to claim 6, wherein the motion sensors further comprise infrared and/or radar sensors.

8. The sports device according to claim 1, wherein the sensor device further comprises electronic, electromechanical and/or mechanical sensors on each of the trampolines to detect the position of a person on the trampolines based on physical characteristics of the trampolines or parts thereof.

9. The sports device according to claim 1, wherein the sports device further comprises a loudspeaker system, wherein the control unit is configured to control the loudspeaker system in dependence on the position data.

10. The sports device according to claim 9, wherein the loudspeaker system further comprises a plurality of loudspeakers.

11. The sports device according to claim 10, wherein the loudspeakers are arranged circumferentially around the jumping field.

12. The sports device according to claim 10, wherein one of the loudspeakers is associated with each of the trampolines.

13. The sports device according to claim 9, wherein the sports device further comprises one or more switching devices for completely switching off the lighting system and/or the loudspeaker system.

14. The sports device according to claim 1, wherein pads and/or obstacles are arranged between the trampolines.

15. The sports device according to claim 1, wherein the jumping field is surrounded by a net or by a grid.
